(19) United States
(12) Patent Application Publication
(10) Pub. No.: US 2023/0059090 A1
(43) Pub. Date: Feb. 23, 2023

(54) METHOD FOR SUPPRESSING AMBIGUOUS MEASUREMENT DATA FROM ENVIRONMENTAL SENSORS

(71) Applicant: MERCEDES-BENZ GROUP AG, Stuttgart (DE)

(72) Inventors: Rüdiger JORDAN, Stuttgart (DE); Fábio CORREIA, Stuttgart (DE); Philipp Ferdinand RAPP, Tübingen (DE); Diego GIL VAZQUEZ, Stuttgart (DE); Stefan LANG, Benningen (DE); Peter BROßEIT, Stuttgart (DE); Tobias HOHENTHANNER, Stuttgart (DE)

(21) Appl. No.: 17/789,832

(22) PCT Filed: Dec. 14, 2020
(86) PCT No.: PCT/EP2020/085902

§ 371 Date: Jun. 29, 2022

(30) Foreign Application Priority Data
Dec. 30, 2019 (DE) 10 2019 135 851.5

(51) Int. Cl. B60W 40/105

(52) U.S. Cl. CPC B60W 40/105; B60W 2420/52; B60W 2554/4049; B60W 2420/42; B60W 2554/4041; B60W 2554/20

(57) ABSTRACT

A method for eliminating sensor errors, in particular ambiguities when detecting dynamic objects, by a control device, is provide. Measurement data are received from at least one first sensor and object hypotheses are formed from the received measurement data. Data of at least one reference object, which is detected based on measurement data from at least one second sensor, are received. The formed object hypotheses are compared with the at least one detected reference object. Object hypotheses that do not match the detected reference object are rejected. A method for eliminating sensor errors, in particular ambiguities when detecting static objects is also provided.

### BACKGROUND AND SUMMARY OF THE INVENTION

Exemplary embodiments of the invention relate to a method for eliminating sensor errors, in particular ambiguities, in a detection of dynamic objects and to a method for eliminating sensor errors, in particular ambiguities, when detecting static objects. Furthermore, the exemplary embodiments of the invention relate to a control device, a computer program, and a machine-readable storage medium.

### PRIOR ART

To implement automated driving functions, environmental sensors, such as radar sensors, LIDAR sensors or camera sensors are usually required. Other road users or dynamic objects as well as static objects in the vehicle environment can be detected and measured using environment sensors to enable an automated response of the driving function.

However, the currently available environmental sensors and the evaluation of the corresponding measurement data can result in erroneous results, such as false-positive or false-negative results, which can lead to incomprehensible or dangerous responses of the automated driving function. In the case of assisted driving functions, such as the emergency brake assistant, erroneous results can be suppressed, if necessary, as it is possible to deactivate the assisted driving function and hand over vehicle control to a driver at any time. This means, for example, that automatic emergency braking cannot be carried out. Such suppression of erroneous results is not possible for automated and, in particular, driverless driving functions due to the lack of a driver.

When using radar sensors for angle measurement, it is often possible for sensor errors to occur in the form of ghost targets or false-positive results. The ghost targets can arise in particular due to ambiguities and can be measured at an angle of, for example, 0° and 30°. If the wrong decision is made in the signal processing, this may result in a false detection and thus may compromise safety.

Exemplary embodiments of the invention are directed to a method for reducing error rates, in particular false-positive and false-negative rates, of an environmental sensor.

According to one aspect of the invention, a method is provided for eliminating sensor errors, in particular ambiguities when detecting dynamic objects, by a control device. The ambiguities can result in particular from false positives and thus can result in multiple detected objects or object hypotheses. Dynamic objects are preferably moving road users. The objects can, for example, be measurable in an environment of a mobile unit, wherein the control device and the sensors, for example, are installed on the mobile unit.

In one step, measurement data are received from at least one first sensor and object hypotheses are formed from the received measurement data. The at least one first sensor can, for example, be a radar sensor, a LIDAR sensor, ultrasonic sensor, and the like. For the measures for resolving ambiguities, such as angular ambiguities, determined ambiguous object hypotheses, for example in the form of angular hypotheses, are determined or received.

For example, real measured objects may provide ambiguous angle measurements where only one of the angle hypotheses is correct.

In a further step, data of at least one reference object, which is detected based on measurement data from at least one second sensor, are received. This allows a so-called reference object method to be used to eliminate ambiguities. In order to be able to distinguish between correct and incorrect object hypotheses in a technically simple way, data from other environmental sensors or the at least one second sensor are used. If an object is detected stably and unambiguously by the second sensor, this object can be defined as the reference object.

Subsequently, the formed object hypotheses are compared with the at least one detected reference object. Object hypotheses that do not match the detected reference object are preferably rejected. Such an object hypothesis or angle hypothesis that matches the reference object, especially in terms of location, can be selected based on a first sensor embodied, for example, as a radar sensor. All other object hypotheses are discarded and can thus no longer lead to ghost targets.

As a result of the method, additional information from further sensors can be used to correct sensor errors, such as ambiguities, at an early stage. This can avoid or at least reduce the occurrence of both false-positive and false-negative results or object hypotheses.

Avoiding sensor errors close to the sensor can also prevent incorrect or missing measured values in higher layers of the signal processing chain. Measurement data from other environmental sensors as well as measurement data from inertial measurement units can be used as a source of information.

The control device and the sensors can be arranged in a mobile unit, which can be operated in an assisted, partially automated, highly automated, and/or fully automated or driverless manner in accordance with the BASt standard. For example, the mobile unit can take the form of a vehicle, a robot, a drone, a watercraft, a rail vehicle, a robot taxi, an industrial robot, a utility vehicle, a bus, an airplane, a helicopter, and the like.

Based on the increasing use of sensors in mobile units, the method can be implemented without a high technical effort. In particular, the reliability of the measurement data provided can be increased without additional costs, since the necessary sensors, such as LIDAR sensors or radar sensors, are being installed in an increasing number of mobile units.

In one embodiment, following the method or as part of the method, a vehicle can be controlled based on the corrected or cleaned measurement data from the sensors. By eliminating sensor errors from the measurement data, the safety of all involved road users can be increased.

According to another aspect of the invention, there is provided a method for eliminating sensor errors, in particular ambiguities, when detecting static objects by a control device. Static objects are preferably immovable objects. For example, static objects can be in the form of parked vehicles, trees, buildings, and the like.

In one step, measurement data are received from at least one first sensor and object hypotheses are formed from the received measurement data. Static real measured objects can also provide ambiguous object hypotheses or angle hypotheses where only one of the object hypotheses is correct and the remaining object hypotheses can be traced back to ambiguities. Thus, a so-called stationary target assumption can be made. For this purpose, the speed of the first sensor or the mobile unit on which the first sensor is mounted must be known. Based on the speed, speeds of the formed object hypotheses can be calculated. The speeds can preferably be calculated as absolute speeds.

In a further step, it is checked whether at least one object hypothesis represents a static object based on the calculated speed. Subsequently, if at least one object hypothesis is determined as representing a static object, all other object hypotheses are rejected. Static objects can also have ambiguous object hypotheses or, in the case of a radar measurement, can generate angle hypotheses. If the incorrect object hypothesis is selected, incorrect speeds may be assigned to real static objects and the objects can be classified as dynamic. Moving or dynamic objects have a high relevance for the driving functions, as they are usually other road users. For this reason, moving object hypotheses caused by stationary targets or static objects are particularly critical, as both the position and the speed may be incorrect. It is therefore advantageous to assume a determined object hypothesis or location as the stationary target if one of the object hypotheses or angle hypotheses supports it. This assumption can be made since a stationary target hypothesis or static object hypothesis is very unlikely in the case of a dynamic object.

A reference object can also be used here to eliminate ambiguities. In this way, the method can be additionally supported by the method for eliminating sensor errors, in particular ambiguities, when detecting dynamic objects. For example, if a reference object is present, an object hypothesis overlapping with the reference object can be selected and all other object hypotheses can be rejected.

The two methods according to the invention can be used, for example, in a landmark detection for a landmark-based vehicle localization.

According to a further aspect of the invention, there is provided a control device, wherein the control device is designed to carry out the method. The control device can be, for example, a control device within the vehicle, a control device external to the vehicle, or a server unit external to the vehicle, such as a cloud system. The control device can preferably receive and process measurement data from the at least one measurement antenna and/or measurement data from sensors of the at least one mobile unit.

Furthermore, according to one aspect of the invention, there is provided a computer program comprising commands which, when the computer program is run by a computer or a control device, cause the computer or control device to carry out the method according to the invention. According to a further aspect of the invention, a machine-readable storage medium is provided, on which the computer program according to the invention is stored.

According to one exemplary embodiment, a comparison of the formed object hypotheses with the at least one detected reference object marks rejected object hypotheses as “erroneous” and/or positions at which the rejected object hypotheses were determined as “unreliable”. This information and marking can be stored in a central server unit or in the control device and can be made available to other subscribers and mobile units. This allows the rejected object hypotheses to be used to mark other nearby locations or object hypotheses as “unreliable”. These unreliable object hypotheses can subsequently be treated more restrictively in a downstream object tracking operation or can be discarded. Such a procedure is therefore useful because a reference object is not always available to correctly resolve all ambiguity. For example, if more than one object hypothesis is confirmed by a reference object, the most probable object hypothesis is selected and the less probable object hypothesis is rejected.

In a further embodiment, the object hypotheses are formed as angle hypotheses from measurement data from at least one radar sensor. Hereby, ambiguous or erroneous angle hypotheses can be eliminated by one of the methods according to the invention.

According to a further exemplary embodiment, the at least one reference object is determined from measurement data from at least one second sensor, which is different from the at least one first sensor. For example, the reference object can be determined by evaluating measurement data from a second sensor, which is designed as an additional radar sensor, LIDAR sensor, camera sensor, ultrasonic sensor, and the like. Based on measurements of different sensor types or sensor classes, the elimination of ambiguities can be particularly robust.

According to a further embodiment, the at least one object hypothesis represents a static object when a speed for the object hypothesis lower than a limit value is calculated. For example, in the case of an angle measurement by a radar sensor, the following condition, simplified for straight-line driving, can be tested with regard to each of the angle hypotheses:

|vᵣ+v_{ego}*cos(thetaᵢ)|<t

Here, vᵣ corresponds to a measured relative speed, v_{ego} to the determined speed of the mobile unit with the first sensor, theta; to the determined angle of an angle hypothesis, and t to the limit value or threshold. If a speed assigned to the object hypothesis is determined to be below the limit value of, for example, 1 m/s, the object hypothesis is defined as an object hypothesis of a static object.

According to a further exemplary embodiment, for at least two object hypotheses, each representing a static object, the corresponding probability for the object hypotheses is calculated, wherein the object hypothesis with the lower probability is rejected. In this way, additional ambiguities can be eliminated particularly efficiently.

According to a further embodiment, all object hypotheses except for at least one object hypothesis representing a static object is rejected if no reference object is received. This means that technically simple decision-making can be implemented, in which a stationary target hypothesis or an object hypothesis representing a static object is selected if no reference objects are available. All other object hypotheses are rejected.

### BRIEF DESCRIPTION OF THE DRAWING FIGURES

In the following, preferred exemplary embodiments of the invention are explained in more detail with the aid of highly simplified schematic diagrams. In these:

FIG. 1 shows a schematic traffic situation with a dynamic object to illustrate a method according to an embodiment,

FIG. 2 shows a schematic traffic situation with static objects to illustrate a method according to a further embodiment, and

FIG. 3 shows a schematic flow chart illustrating a method.

### DETAILED DESCRIPTION

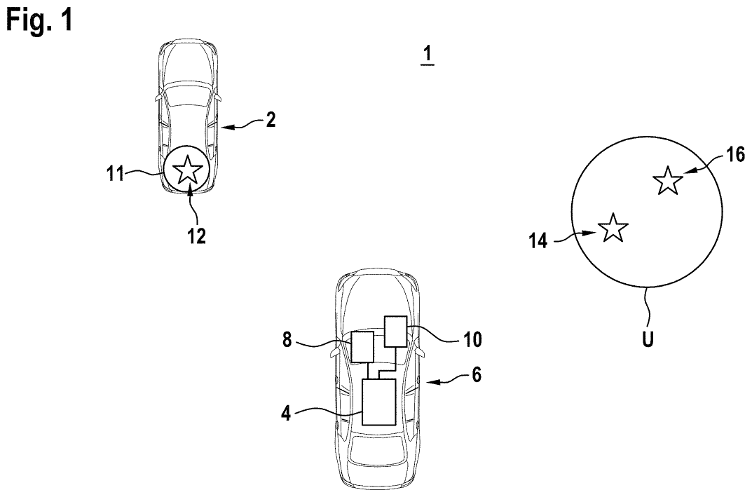

FIG. 1 shows a schematic traffic situation 1 with a dynamic object 2 to illustrate a method according to an embodiment. The method is used in particular to eliminate sensor errors, such as ambiguities in a detection of dynamic objects 2, by a control device 4.

The control device 4 is installed in a mobile unit 6, which is embodied as a motor vehicle that can be operated in automated fashion. The mobile unit 6 has a first sensor 8 and a second sensor 10.

The first sensor 8 is embodied, by way of example, as a radar sensor and the second sensor 10 as a LIDAR sensor. The control device 4 can receive and evaluate measurement data from the sensors 8, 10. For this purpose, the control device 4 is connected to the sensors 8, 10 for data transfer.

To distinguish between correct object hypotheses 12 and erroneous object hypotheses 14, which are based on measurement data from the first sensor 8, information from the second sensor 10 can be used. For example, a stably determined reference object 11 and in particular a position of the reference object 11 can be used to confirm one of the two object hypotheses 12.

Other object hypotheses 14, 16 are subsequently rejected. The positions where the rejected object hypotheses 14, 16 are present are marked as an unreliable region U.

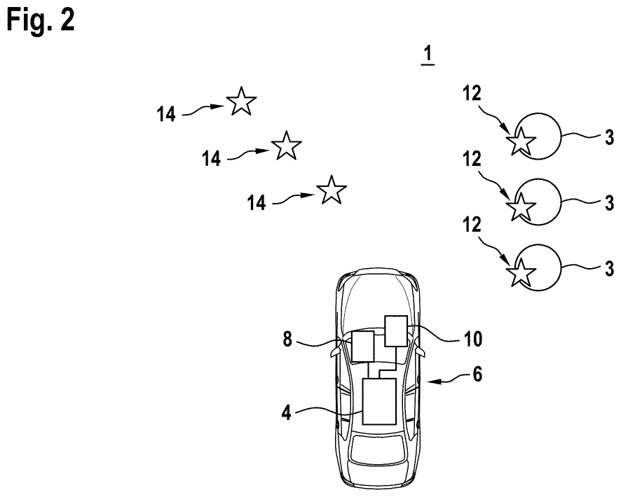

FIG. 2 shows a schematic traffic situation 1 with static objects 3 to illustrate a method according to a further embodiment. The method is used to eliminate sensor errors, in particular ambiguities, when detecting static objects 3.

Measurement data from the first sensor 8 are evaluated here, and a plurality of object hypotheses 12, 14 are formed. There are no reference objects 11 that can be used by the control device 4.

If the incorrect object hypothesis 14 or angle hypothesis is selected by the signal processing of the control device 4, the result is an incorrect calculated speed over ground for the corresponding object hypothesis 14. This allows static objects 3 to be identified as dynamic or moving objects 2.

Moving objects 2 have a high relevance for the driving function, since they are usually other road users.

Stationary targets 3 classified as moving objects 2 are particularly critical, since both their position and their speed are erroneous. It is therefore advantageous to assume a location as a stationary target or as a static object 3 if one of the object hypotheses 12 or angle hypotheses support this. All other object hypotheses 14 are rejected.

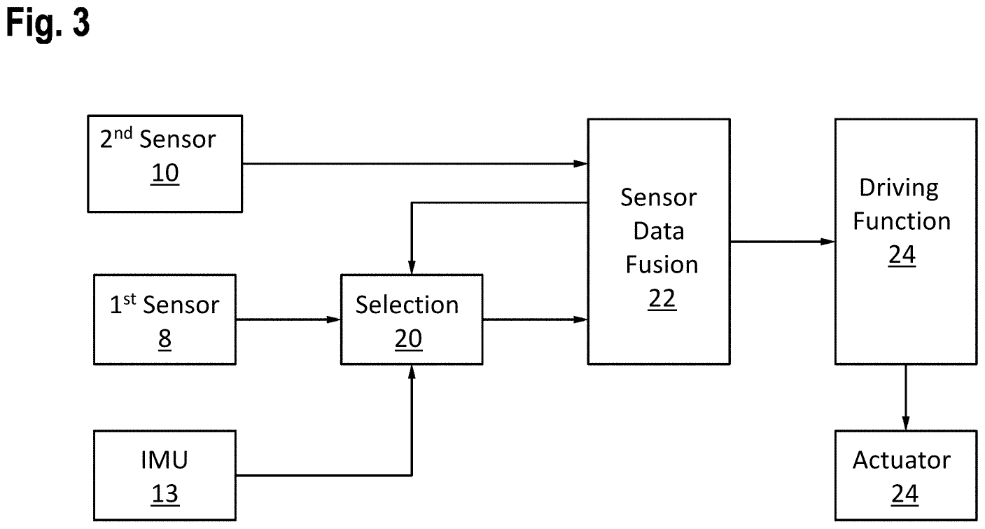

FIG. 3 shows a schematic flow chart illustrating a method according to a further embodiment.

Measurement data are received from at least one first sensor 8. The first sensor 8 can be a radar sensor, for example. Angle hypotheses are also formed and transmitted with the measurement data.

Parallel to this, measurement data from an inertial measurement unit 13 can be received. The measurement data can include, for example, a speed, acceleration values and yaw rates of the vehicle 6.

Based on the measurement data of the first sensor 8 and the inertial measurement unit 13, a selection 20 of an object hypothesis is made, and thus ambiguities are eliminated.

The selection 20 of an object hypothesis can be implemented by one of the methods according to the invention, so that only correct object hypotheses 12 are forwarded for further processing, such as object tracking and measurement data fusion 22.

Measurement data from a second sensor 10, such as a LIDAR sensor 10, are used both for sensor data fusion 22 and for object hypothesis selection 20, for example, to provide reference objects 11.

The fused measurement data can then be used to implement driving functions 24. Here, the driving function 24 can have direct or indirect access to a vehicle actuator 26, such as braking functions, acceleration functions and steering functions. In addition to the driving function 24, the data determined and forwarded by the selection 20 of the object hypothesis can also be used in a landmark-based localization.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-13. (canceled)

14. A method for eliminating sensor errors in the form of ambiguities when detecting dynamic objects, the method comprising:
receiving, by a control device, measurement data from at least one first sensor;
forming, by the control device, object hypotheses from the received measurement data;
receiving, by the control device, data of at least one reference object, which is detected based on measurement data from at least one second sensor;
comparing, by the control device, the formed object hypotheses with the measurement data of the at least one detected reference object; and
rejecting, by the control device, object hypotheses of the formed object hypotheses that do not match the measurement data of the detected reference object.

15. The method of claim 14, wherein
rejected object hypotheses of the formed object hypotheses are marked as erroneous, or
positions at which the rejected object hypotheses of the formed object hypotheses are determined and are marked as unreliable.

16. The method of claim 14, wherein the formed object hypotheses are formed as angle hypotheses from measurement data from at least one radar sensor, which is one of the at least one first sensor.

17. The method of claim 14, wherein the at least one detected reference object is determined from measurement data from the at least one second sensor, which is different from the at least one first sensor.

18. A method for eliminating sensor errors in the form of ambiguities when detecting static objects, the method comprising:
receiving, by a control device, measurement data from at least one first sensor;
forming, by the control device, object hypotheses from the received measurement data;
calculating, by the control device, speeds of the formed object hypotheses;
checking, by the control device based on the calculated speed, whether at least one object hypothesis represents a static object; and
rejecting, by the control device when at least one determined object hypothesis represents the static object, all formed object hypothesis other than the at least one determined object hypothesis.

19. The method of claim 18, wherein the at least one object hypothesis represents a static object when a velocity lower than a limit value is calculated as the speed of the at least one object hypothesis.

20. The method of claim 18, wherein if at least two object hypotheses represent one static object, probabilities for the at least two object hypotheses are calculated, wherein an object hypothesis of the at least two object hypotheses with a lower probability is rejected.

21. The method of claim 18, wherein all of the formed object hypotheses except for at least one object hypothesis representing the static object are rejected if no data of a reference object are received.

22. The method of claim 18, wherein
rejected object hypotheses marked as erroneous, or
positions at which the rejected object hypotheses are determined are marked as unreliable.

23. The method of claim 18, the formed object hypotheses are formed as angle hypotheses from measurement data from at least one radar sensor, which is one of the at least one first sensor.

24. A non-transitory machine-readable storage medium on which a computer program is stored, wherein when the computer program is executed by a control device of a vehicle, the computer program causes the control device to:
receive measurement data from at least one first sensor;
form object hypotheses from the received measurement data;
receive data of at least one reference object, which is detected based on measurement data from at least one second sensor;
compare the formed object hypotheses with the measurement data of the at least one detected reference object; and
reject object hypotheses of the formed object hypotheses that do not match the measurement data of the detected reference object.
